(19) United States
(12) Patent Application Publication
(10) Pub. No.: US 2006/0125259 A1
(43) Pub. Date: Jun. 15, 2006

(54) Stretch film lifting apparatus

(75) Inventors: Richard Allegretti, Schiller Park, IL (US); Pawel Sulisz, Itasca, IL (US)

Correspondence Address: LEVENFELD PEARLSTEIN;Intellectual Property Department, 2 North LaSalle, Suite 1300, CHICAGO, IL, 60602, US

(73) Assignee: ARPAC, L.P., Schiller Park, IL (US)

(21) Appl. No.: 11/268,259

(22) Filed: Nov. 7, 2005

Related U.S. Application Data
(60) Provisional application No. 60/628,346, filed on Nov. 15, 2004.

(51) Int. Cl. B25J 1/00

(52) U.S. Cl. 294/94

(57) ABSTRACT

The instant invention relates to an expandable mandrel actuator apparatus for manually handling a heavy cylindrical roll of rolled material wherein said expandable mandrel actuator apparatus comprises an expandable mandrel and is inserted within said heavy cylindrical roll to form a single package. The instant invention also relates to a method for manually handling a heavy cylindrical roll of rolled material wherein an actuator apparatus comprising an expandable mandrel inserted within the inner roll of said rolled material forms a single package of said expandable mandrel and said cylindrical roll as a means for an individual to easily engage, maneuver, and lift said single package into position on a roll material dispensing machine.

### CROSS REFERENCE TO RELATED APPLICATIONS

This application claims the filing date of provisional patent application entitled STRETCH FILM LIFTING APPARATUS, Ser. No. 60/628,346, filed Nov. 5, 2004.

### FIELD OF THE INVENTION

This invention relates generally to a method for manually handling a heavy cylindrical roll of rolled material comprising a roll of sheeting rolled into a single package. The sheeting material can be a plastic film, felted sheeting of paper or any sheeting material in the form of a rolled package, which is to be unrolled as, required by the required use of the sheeting material. The cylindrical roll is typically of a size ordinarily suited for placement upon a dispensing structure by manual means or by mechanical means such as by a mechanical lifting mechanism including self-propelled machines for hoisting and transporting heavy objects by means of metal fingers inserted under the load as a forklift.

The invention further relates generally to an actuator apparatus for engaging and easily handling a heavy cylindrical roll of rolled material comprising an actuator apparatus and a roll of sheeting as a single package. The invention particularly relates to a method and actuator apparatus to easily engage, maneuver and manually lift a cylindrical roll of stretch wrapping film into position on a film-dispensing device wherein the cylindrical roll of stretch wrapping film is locked in place on the film-dispensing device. The actuator apparatus also facilitates a locking engagement and maneuvering of a cylindrical roll of rolled material by mechanical lifting means as a forklift.

The invented method comprises the insertion of an invented expandable mandrel within the internal cylinder of the roll of wrapping film. The expandable mandrel is expanded into position to lock within the internal cylinder of the film roll and provides a means of manually grasping, maneuvering and lifting the film roll.

The invented actuator apparatus comprises an expendable mandrel wherein the expandable mandrel is expanded and retracted by control means. A first thrust expandable mandrel locks in place within the internal cylinder of the roll of wrapping film. A second thrust pedestal mandrel member of the expandable mandrel comprises a locking engagement means with the load support surface of the film carriage of the stretch wrap apparatus. The locking engagement means is the second thrust pedestal mandrel member of the expandable mandrel apparatus configured to fit a supporting film carriage.

The instant invention is a unique device for engaging a roll of sheeting in a locking procedure. The locked device and roll of sheeting as a single package are easily manually handled and lifted as a single package to place the roll package upon a dispensing structure and lock the roll package in position upon the dispensing structure to permit the dispensing structure to dispense the roll of sheeting as required.

More specifically, the instant invention is a unique expandable shaft and mandrel upon which a roll of film is mounted. The mounted film roll in turn is mounted upon a film carriage of a mechanical stretch-wrap apparatus that wraps a container or a pallet of packages with a stretch-wrap flexible material supplied by the mounted film roll. The flexible material can be supplied as a film or a netting. The mechanical stretch-wrap apparatus operates by rotating a loaded pallet and applying under tension a flexible stretch material in a winding manner to the pallet load. The mounted film or netting roll is therefore under tension to supply the rolled material to the rotating load. The expandable shaft and mandrel upon which the rolled material roll is mounted is locked in place upon the film or netting support carriage to provide tension to the winding procedure.

In operation of the stretch-wrap apparatus, the roll of film material is dispensed by film dispensing means including a vertically upstanding structure which supports a film carriage which is able to move vertically upwardly or downwardly as controlled by a control means. Typically extending upwardly from the carriage is the expandable shaft and mandrel adapted to receive a spool or roll containing stretchable plastic film. The locking connection between the spool or roll and mandrel apparatus is such that they rotate together. Braking means, not shown, are provided for applying a frictional drag or braking force on the mandrel apparatus while the mandrel apparatus and film roll are rotating.

In operation of a wrapping apparatus of this type, which provides a spiral wrap, the platform upon which the mandrel and film roll are supported rotates while the carriage, which supports the platform, moves up and down during the wrapping procedure.

In a typical prior art operation of a wrapping apparatus for stretch film, the connection between the support spindle, which supports the spool or roll containing stretchable plastic film, requires a means to provide wrapping tension. In a typical prior art wrapping procedure, the dispensed film can be entrapped between a cylindrical roller and the frictional upper surface of a friction pad to provide tension.

In a typical prior art operation of a wrapping apparatus for stretch film, the spool or roll containing stretchable plastic film is manually moved and lifted by the operator to fit upon a support spindle upon the support platform on the film carriage. The roll of film is typically heavy and can be difficult to maneuver onto the support spindle located upon the support platform of the apparatus. The internal cylinder of the roll of film can fail to engage the support spindle in a friction contact to provide a firm frictional connection. The spool and roll of film can fail to rotate together in a locked engagement.

It is an object of this invention to provide a unique device for an operator to manually and ergonomically handle and lift heavy rolls of plastic film for placement upon a wrapping apparatus. The device comprises a first expandable mandrel with operational means at one end and a second thrust pedestal mandrel member at the other end. The first expandable mandrel is inserted within the inner cylindrical roll of the film roll. The first expandable mandrel is thereupon expanded to provide a locking engagement with the inner cylindrical roll to become part of the roll of film. The second thrust pedestal mandrel member at the other end is positioned to engage the support carriage of the wrapping apparatus. The extension of the two ends of the expandable mandrel beyond the two roll ends of the film roll provides means of maneuvering and lifting the roll of film, either by a lifting mechanism, such as a forklift or by manual means using ergonomically correct procedures.

It is the object of this invention to provide an expandable mandrel wherein a first expandable mandrel locks in place within a film roll and locks in place the package of the mandrel and film roll on the support platform of a film carriage of a stretch wrap apparatus wherein the means for so locking the film roll package in place comprises a second thrust pedestal mandrel member of said expandable mandrel apparatus.

It is an object of this invention to provide an expandable mandrel that locks into place on a stretch warp apparatus easily and eliminates the procedure of tightening the film roll in place upon a fixed spindle on the support platform of a stretch wrap apparatus and provides means of quick load and unload of the film roll.

It is an object of this invention to provide an expandable mandrel apparatus as a means of reducing operator injury by reducing operator's need to bend over to lift film rolls and by facilitating use of mechanical lifting devices.

It is an object of this invention to provide an expandable mandrel apparatus which comprises an expandable means for insertion within the cylindrical inner roll of a roll of stretch wrap film which expandable means is controllable by two handles of the expandable mandrel apparatus wherein one handle operates a first thrust mandrel and a second handle controls the mandrel shaft wherein the handles operate to “open” and “close” the expandable mandrel apparatus.

It is a further object of this invention to provide a method for maneuvering and lifting a heavy cylindrical roll of plastic film by an operator whereby the roll of plastic film has an expandable mandrel apparatus inserted within the cylindrical inner roll of said roll of plastic film to provide a means of easy maneuvering and lifting the film roll by manual and mechanical means to position and lock the film roll upon a stretch wrap apparatus quickly which method comprises (a) insertion of said expandable mandrel apparatus within the cylindrical inner roll of said plastic film; (b) expansion of said expandable mandrel apparatus within said inner roll to firmly secure and lock said mandrel to said inner roll of said plastic film to form a single package; (c) the operator maneuvering and lifting said single package by ergonomically correct procedures when weight of said single package is within limits of manual ability of operator of said expandable mandrel; and (d) maneuvering and lifting said single package by mechanical means when weight of said single package is beyond limits of manual ability of operator of said expandable mandrel using protruding ends of said expandable mandrel as means of lifting said single package.

### DESCRIPTION OF THE PRIOR ART

Pallet wrapping machines are well known in the prior art and provide an apparatus for making a unified package of multiple containers of multiple products stacked upon a pallet for ease of transport and handling. The wrapping material can be paper or plastic film or netting of stretch and of heat shrinkable characteristics.

It is known to provide a spiral wrap apparatus for a palletized load, wherein a rotatable platform is situated horizontally for receiving the palletized load, and in which apparatus a means for dispensing film adjacent to the rotatable platform includes a vertical spindle on which a spool of suitable stretchable film can be dispensed. The kind of apparatus to which this invention pertains is that in which the spindle supporting the spool of film is located upon a carriage assembly which is adapted to be raised and lowered in the vertical direction while the wrapping is proceeding. The spindle is typically rotatable in its position on the carriage assembly and the connection between the spool of film and the spindle is preferably such that they rotate together.

The film dispensing means accordingly includes a spool containing stretchable plastic film, an upright rotatable spindle, a carriage assembly, and a braking means for applying a frictional drag or braking force on the dispensed film or spindle while the spindle is rotating.

In operation of a typical prior art wrapping apparatus, at least one operator is present to manually place the spool of film upon the upright rotatable spindle, to feed the free end of the film to the wrapping apparatus and to replace the used spool of film when necessary.

It would facilitate the wrapping operation to provide a means for quickly loading and unloading a film spool with reduced risk of injury to the operator by enabling the operator to ergonomically lift the stretch wrap film spool in position on the stretch wrap machine and to lock the film spool in position on the stretch wrap machine for a quick load and unload.

In the prior art, a number of devices are taught as support means for a roll of stretch film on a stretch wrap apparatus. U.S. Pat. No. 4,044,529 teaches a fixed roll of film is threaded on a vertical post secured to the top surface of a horizontal platform adjacent to the load to be wrapped. U.S. Pat. No. 4,034,536 teaches a packaging machine wherein the machine is provided with a spindle carrying a roll of film packaging material that is unwound as a continuous web by a conventional web-feed mechanism of a series of rollers. U.S. Pat. No. 4,008,554 teaches two horizontal spindles as carrying rolls of plastic film that are mounted on a support frame. U.S. Pat. No. 5,155,970 teaches a means for dispensing a film web onto a load which means includes a film carriage having a film web supply roll, prestretch rollers and a guide roller. U.S. Pat. No. 6,293,074 B1 teaches a package material dispenser that dispenses a sheet of packaging material in a web form. The dispenser includes a roll of packaging material within a roll carriage, which may include a variety of rollers to stretch the material. The roll carriage is mounted on an L-shaped arm for supporting and rotating the roll carriage of the film dispenser in a circle about the load to be wrapped.

However, as is evident in the above review of prior art, to the inventor's knowledge there has been no device made available at the present time which provides a means for ergonomically lifting and locking a stretch wrap film roll into position on a stretch wrap machine easily and quickly which reduces risk of physical injury to the individual manually maneuvering and lifting the film roll wherein the invented device provides a means to quickly load and unload the film roll and wherein the invented device carrying its film roll locks in place within the film roll and locks in place on the stretch wrap machine quickly and easily.

### SUMMARY OF THE INVENTION

The present invention comprises an actuator apparatus and method for manually handling a heavy roll of plastic film, including locking the actuator apparatus within the roll of plastic film, maneuvering and lifting the heavy roll by the individual operator, to place and lock said roll in position upon a dispensing apparatus wherein said actuator apparatus permits said individual operator to maneuver and lift said roll of plastic film in an ergonomically correct physical movement wherein said actuator apparatus comprises an expandable mandrel apparatus consisting of a first thrust expandable mandrel component, a second thrust pedestal mandrel member component, an activating compression spring, a cone-shaped pusher head and slide cone operating in conjunction therewith, four projecting handles of which a first handle engages a first thrust expandable mandrel member component; a second handle engages the mandrel shaft that supports the components of the first thrust expandable mandrel and supports a second thrust pedestal mandrel member component, the handles serving to operate the expandable mandrel apparatus to “open” and “close” the expandable mandrel apparatus.

### BRIEF DESCRIPTION OF THE DRAWINGS

FIG. 1 is a top view of an actuator apparatus of a preferred embodiment of this invention.

FIG. 2 is an end view of the actuator apparatus illustrating the second thrust pedestal mandrel member on the exterior end of the expandable mandrel, which locks in position in a locking engagement with the load support surface of the film carriage of the film wrapping apparatus.

FIG. 3 is an end view of the actuator apparatus illustrating the side-by-side positioning of the four handles of the actuator apparatus, which control the operation of the apparatus.

FIG. 4 is a side view of application of a preferred embodiment of this invention upon a stretch wrap machine.

### DETAILED DESCRIPTION OF THE EMBODIMENT

The present invention is designed to be used with any type of stretchable material available upon a roll with an internal cylinder of the material roll. The present invention can be operated to be locked within and released from within the internal cylinder of the material roll by the operating handles. The pedestal mandrel of the expandable mandrel of the present invention engages the film support carriage in a locking configuration as a means of wrapping tension upon unwinding the installed film roll upon the film wrapping apparatus. The stretch film wrapping apparatus is not a component of the instant invention, but embodies the type of stretch wrap apparatus upon which the instant invention is designed to be used.

The components of the stretch film wrapping apparatus, which utilize the invented stretch film lifting apparatus, are necessarily described to illustrate that the instant invented stretch film lifting apparatus facilitates the operation of the stretch film wrapping apparatus. The components of the stretch film wrapping apparatus typically comprise a turntable, a supply of stretch wrap flexible material from a supply source comprising a roll of the flexible material, a flexible material, and a means of supporting the roll of flexible material upon the flexible material carriage. The load to be wrapped is on the turntable. The operator initiates the wrapping cycle by manually or mechanically positioning the stretch wrap material onto the load. Upon rotation of the turntable supporting the load, the stretch wrap material begins to wrap the load under tension as the turntable rotates faster than the film supply is supplied. The flexible material carriage accordingly applies tension to the film material to stretch wrap the load.

The operator of the stretch film wrapping apparatus typically, manually or mechanically, loads and unloads the roll of flexible material. The instant invention provides a means of facilitating the operator's procedures in quick and ergonomically maneuvering and handling of the rolls of flexible material necessary to operate the stretch film wrapping apparatus. The instant invention is designed to be installed upon the stretch film wrapping apparatus with few modifications of the stretch film wrapping apparatus. The specific modification of a typical stretch film wrapping apparatus requires only that the shaft or spindle upon which the roll of flexible material is mounted be replaced by the instant invented stretch film lifting apparatus.

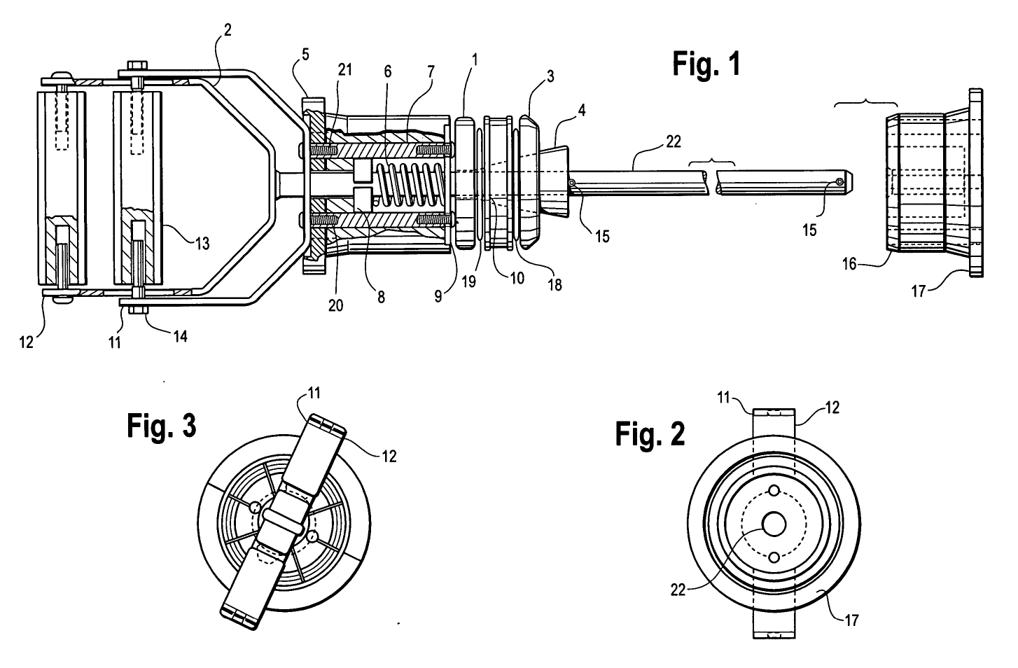

Referring to FIG. 1, the components of the instant invention comprise a first thrust mandrel (5), a compression spring (6), which operates a cone shaped pusher head (3) and cone slide (4). A second thrust pedestal mandrel member (17) positioned on end of the shaft (7) is designed to engage the film support carriage (32) of the stretch film wrapping apparatus.

Referring to FIG. 1, the components of the instant invention comprise a first thrust mandrel (5) embodiment of a cone shaped pusher head (3), external snap ring (10), and inside base plate (1) and O-rings (18) and (19). The first thrust mandrel (5) embodiment is caused to operate against the slide cone (4) in conjunction with the compression spring (6) and the shaft collar clamp (8) by movement of the shaft handle (2) to compress the compression spring (6). Compression of the compression spring (6) causes the embodiment of the first thrust mandrel (5) to engage the slide cone (4) to cause expansion of the first thrust mandrel (5) to engage the internal cylinder of the material film roll in a locking action. The locking action of the first thrust mandrel (5) is released by release of the compression of the compression spring (5) by the handle (2), which releases the engagement of the first thrust mandrel (5) from the internal cylinder of the material film roll.

Within the first thrust mandrel (5) embodiment is the shaft spacer (7), which encloses compression spring (6). The shaft spacer (7) is attached by bolts (20) and (21) to the external handle (13).

The external end of the shaft (22) supports the second thrust pedestal mandrel member (17) on the mounting bracket (16). The second thrust pedestal mandrel member (17) is adapted to engage the film support carriage (32) of the stretch wrap machine.

Referring to FIG. 2, the second thrust pedestal mandrel member (17) is illustrated with activating handles (11) and (12) at the actuating end of the expandable mandrel. The engagement of the shaft (22) with the second thrust pedestal mandrel member (17) is illustrated.

Referring to FIG. 3, the activating handles (11) and (12) are illustrated with elements of the assembly of the expandable mandrel.

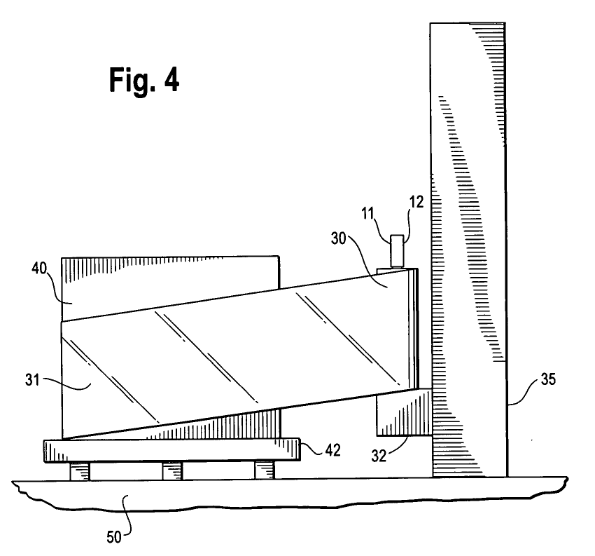

Referring to FIG. 4, as an illustration of application of a preferred embodiment of this invention upon a stretch wrap machine, the cylindrical roll of stretch wrapping film (30) is locked in position on the film support carriage (32). The film support carriage (32) is elevated by a tower (35) for spiral wrapping of the pallet load (40) with the spiral wrapping (31). Activating handles (11) and (12) of the first thrust mandrel embodiment (5) and the shaft (22) (not shown) of the expandable mandrel locked in position within the roll of the stretch wrapping film (30) are shown projecting from the roll (30). The load to be wrapped is on turntable (42) on support surface (50).

In summary, the instant invention comprises an actuator apparatus for manually handling a heavy cylindrical roll of rolled material comprising said actuator apparatus inserted within said heavy cylindrical roll to form a single package, said manually handling including locking said actuator apparatus within said roll for maneuvering and lifting by a single individual and by mechanical lifting means wherein said actuator apparatus comprises an expandable mandrel apparatus comprising: (a) an expandable first thrust mandrel embodiment manually actuated by exterior operating handles to open and close positions within inner cylinder of said heavy cylindrical roll of rolled material, said first thrust mandrel embodiment mounted on a mandrel shaft; (b) a compression spring positioned upon said mandrel shaft within a shaft spacer manually activated by exterior operating handles to lock said expandable first thrust mandrel in open and close positions; and (c) a second thrust pedestal mandrel member on the exterior end of said mandrel shaft to a) engage an outward end of said inner cylinder of said heavy cylindrical roll of rolled material, and b) to engage a supporting material carriage of a stretch wrap machine as a pedestal mandrel member, wherein said actuator apparatus comprises an expandable mandrel apparatus for insertion within the internal cylindrical roll of rolled material, wherein said roll comprises a roll of stretch wrap film, wherein said expandable first thrust mandrel embodiment comprises a pusher head, an external snap ring, an inside base plate and a plurality of O-rings, and wherein said expandable first thrust mandrel embodiment is caused to operate against a slide cone in conjunction with a compression spring and shaft collar clamp by handles to compress said compression spring to expand said expandable first thrust mandrel.

In further summary, the instant invention comprises a method for manually handling a heavy cylindrical roll of rolled material comprising an actuator apparatus consisting of an expandable mandrel and a pedestal mandrel member inserted within the inner roll of said cylindrical roll of rolled material to form a single package of said expandable mandrel and said cylindrical roll as a means for an individual to easily engage, maneuver and manually lift the said single package into position on a rolled material dispensing machine wherein said mandrel is locked in position within said cylindrical roll and is locked in position on said rolled material dispensing machine by said pedestal mandrel member, said cylindrical roll is a roll of stretch wrap film, and said mandrel is locked in position within said roll by said expandable mandrel.

What is claimed is:

1. An actuator apparatus for manually handling a heavy cylindrical roll of rolled material comprising said actuator apparatus inserted within said heavy cylindrical roll to form a single package, said manually handling including locking said actuator apparatus within said roll for maneuvering and lifting by a single individual and by mechanical lifting means wherein said actuator apparatus comprises an expandable mandrel apparatus comprising:
(a) an expandable first thrust mandrel embodiment manually actuated by exterior operating handles to open and close positions within inner cylinder of said heavy cylindrical roll of rolled material, said first thrust mandrel embodiment mounted on a mandrel shaft;
(b) a compression spring positioned upon said mandrel shaft within a shaft spacer manually actuated by exterior operating handles to lock said expandable first thrust mandrel in open and close positions; and
(c) a second thrust pedestal mandrel member on the exterior end of said mandrel shaft to a) engage an outward end of said inner cylinder of said heavy cylindrical roll of rolled material, and b) to engage a supporting material carriage of a stretch wrap machine as a pedestal mandrel member.

2. The actuator apparatus of claim 1 wherein said actuator apparatus comprises an expandable mandrel apparatus for insertion within the internal cylindrical roll of rolled material.

3. The roll of rolled material of claim 2 wherein said roll comprises a roll of stretch wrap film.

4. The actuator apparatus of claim 1 wherein said expandable first thrust mandrel embodiment comprises a pusher head, an external snap ring, an inside base plate and a plurality of O-rings.

5. The actuator apparatus of claim 1 wherein said expandable first thrust mandrel embodiment is caused to operate against a slide cone in conjunction with a compression spring and shaft collar clamp by handles to compress said compression spring to expand said expandable first thrust mandrel.

6. A method for manually handling a heavy cylindrical roll of rolled material comprising an actuator apparatus consisting of an expandable mandrel and a pedestal mandrel member inserted within the inner roll of said cylindrical roll of rolled material to form a single package of said expandable mandrel and said cylindrical roll as a means for an individual to easily engage, maneuver and manually lift the said single package into position on a rolled material dispensing machine wherein said mandrel is locked in position within said cylindrical roll and is locked in position on said rolled material dispensing machine by said pedestal mandrel member.

7. The method of claim 6 wherein said cylindrical roll is a roll of stretch wrap film.

8. The method of claim 6 wherein said mandrel is locked in position within said roll by said expandable mandrel.
